(19) United States
(12) Patent Application Publication
(10) Pub. No.: US 2015/0012734 A1
(43) Pub. Date: Jan. 8, 2015

(54) BASIC INPUT OUTPUT SYSTEM UPDATE APPARATUS

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/324,420

(22) Filed: Jul. 7, 2014

(30) Foreign Application Priority Data
Jul. 5, 2013 (CN) 201310280742X

(51) Int. Cl. G06F 9/445

(52) U.S. Cl. CPC G06F 8/65
USPC 713/1

(57) ABSTRACT

A basic input output system (BIOS) update apparatus is configured to update the BIOS of a first electronic device. The BIOS update apparatus includes a transfer board and a second electronic device. The transfer board includes a firmware for converting between USB signals and system management bus (SMBUS) signals. The second electronic device includes an update software. The BIOS update apparatus automatically updates the BIOS of the first electronic device when the update software is activated.

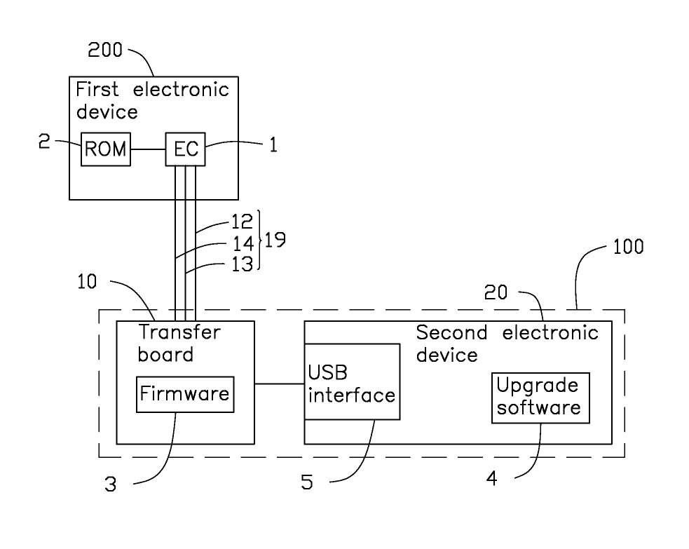

### FIELD

The subject matter herein generally relates to firmware updating.

### BACKGROUND

A basic input output system (BIOS) in an electronic device can need to be updated.

### BRIEF DESCRIPTION OF THE DRAWING

Implementations of the present technology will now be described, by way of example only, with reference to the attached figure.

The figure is a block diagram of an embodiment of a BIOS update apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure describes a basic input output system (BIOS) update apparatus 100, to update a BIOS in a first electronic device 200. In at least one embodiment, the first electronic device 200 can comprise an embedded controller (EC) 1 and a read-only memory (ROM) 2. The ROM 2 is coupled to the EC 1. The BIOS needing to be updated is stored in the ROM 2. The EC 1 can function fully even if the first electronic device 200 is on standby status.

The drawing illustrates the BIOS update apparatus 100. The BIOS update apparatus 100 can comprise a transfer board 10 and a second electronic device 20. The transfer board 10 can comprise a firmware 3 for converting between USB signals and system management bus (SMBUS) signals. The second electronic device 20 can comprise an update software 4 for outputting an updated BIOS to the transfer board 10 through a USB interface 5 of the second electronic device 20.

In the updated process, the first electronic device 200 is on standby, and the transfer board 10 is coupled to the EC 1 of first electronic device 200 through a data bus 12, a clock bus 13, and a ground bus 14 of an SMBUS 19. The second electronic device 20 is coupled to the transfer board 10 through the USB interface 5. After activating the second electronic device 20, the updated BIOS is outputted through the USB interface 5 to the transfer board 10. The firmware 3 of the transfer board 10 converts USB signals type of the updated BIOS to SMBUS signals type, and then outputs the SMBUS signals type to the EC 1 of the first electronic device 200. The updated BIOS is automatically installed into the ROM 2, and the BIOS of the first electronic device 200 is thereby updated.

The BIOS update apparatus 100 can automatically update the BIOS of the first electronic device 200 when the first electronic device 200 is on standby.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A basic input output system (BIOS) update apparatus configured to update a BIOS of a first electronic device, the BIOS update apparatus comprising:
a transfer board comprising a firmware configured to convert between Universal Serial Bus (USB) signals and system management bus (SMBUS) signals; and
a second electronic device comprising a USB interface and an update software;
wherein the transfer board is coupled to an embedded controller (EC) of the first electronic device through an SMBUS; wherein the transfer board is coupled to the USB interface of the second electronic device.

2. The BIOS update apparatus as claimed in claim 1, wherein the transfer board is coupled to the EC through a data bus, a clock bus, and a ground bus of the SMBUS.
